(19) United States
(12) Patent Application Publication
(10) Pub. No.: US 2014/0233078 A1
(43) Pub. Date: Aug. 21, 2014

(54) IMAGE PROCESSING APPARATUS AND IMAGE FORMING APPARATUS

(71) Applicant: Sharp Kabushiki Kaisha, Osaka (JP)

(72) Inventor: Takashi KUROKAWA, Osaka (JP)

(73) Assignee: Sharp Kabushiki Kaisha, Osaka (JP)

(21) Appl. No.: 14/160,726

(22) Filed: Jan. 22, 2014

(30) Foreign Application Priority Data
Feb. 20, 2013 (JP) 2013-030554

(51) Int. Cl. H04N 1/00

(52) U.S. Cl. CPC H04N 1/00588; H04N 1/00779
USPC 358/498

(57) ABSTRACT

An image processing apparatus includes an automatic document feeder for conveying a document to pass through an image reading position for discharging, and a main body portion for irradiating the document with light at the image reading position and receiving reflection light of the irradiated light to read an image of the document, in which the automatic document feeder is provided so as to be able to be opened and closed with respect to the main body portion. The image processing apparatus, while the automatic document feeder conveys a document, irradiates a white plate with light in the absence of the document at the image reading position to read an image thereof and analyzes the read image of the white plate so as to detect opening and closing of the automatic document feeder.

### CROSS-NOTING PARAGRAPH

This non-provisional application claims priority under 35 U.S.C. §119(a) on Patent Application No. 2013-030554 filed in JAPAN on Feb. 20, 2013, the entire contents of which are hereby incorporated herein by reference.

### FIELD OF THE INVENTION

The present invention relates to an image processing apparatus and an image forming apparatus, and more specifically to an image processing apparatus which performs processing for conveying a document by an automatic document feeder capable of being opened and closed with respect to a main body portion to read a document image, and an image forming apparatus which performs image formation of the document image read by the image processing apparatus.

### BACKGROUND OF THE INVENTION

Generally used as an image processing apparatus having a scanner function for reading a document image is one including an automatic document feeder for automatically conveying a document to read an image thereof. This image processing apparatus includes a main body portion having a scanner portion composed of a lamp for exposure and an optical system and a document table on which a document is placed, and an automatic document feeder provided so as to be opened and closed freely with respect to the main body portion. When a document image is read by the scanner function of the image processing apparatus, it is possible that a user opens the automatic document feeder to expose a document loading table of the main body portion, and places a document on a platen glass thereof to perform reading of the document image, or causes the document to be conveyed automatically with the automatic document feeder being in the closed state to perform reading of the document image.

Opening and closing of the automatic document feeder is detected by a reflection-type or transmission-type sensor provided in the automatic document feeder. For example, when a document is set in the automatic document feeder, if the sensor detects that the automatic document feeder is in the opened state, control is performed so that conveyance of a document image is not performed even when an operation for stating a print job is performed.

As such a technology for detecting opening and closing of the automatic document feeder, for example, Japanese Laid-Open Patent Publication No. 2012-29193 describes that with an opening and closing action of an automatic document feeding portion, distribution of the light quantity of external light incident from an opening portion is varied, and based on the detection result of the variation in the distribution of the light quantity, the opening and closing action of the automatic document feeding portion is detected.

In a case where a document is set in the automatic document feeder of the image processing apparatus and a job including an action for reading a document image is started, it is impossible to execute the job appropriately if conveyance of a sheet is executed as it is when the automatic document feeder is opened during execution of the job. For example, if the job is an image forming job for performing image formation on the sheet, a problem is caused that toner and sheets become wasted when an image forming action by the image forming apparatus is executed as the automatic document feeder remains in the opened state.

The image processing apparatus including the automatic document feeder provided so as to be able to be opened and closed with respect to the main body portion as described above is to detect the opened and closed state of the automatic document feeder to perform control of the action for reading a document image, and the like. Accordingly, it is also considered that, when the sensor detects that the automatic document feeder becomes the opened state during conveyance of a document, a job is stopped. However, there also exists an image processing apparatus which does not include a sensor for detecting opening and closing of the automatic document feeder and is not able to detect opening and closing of the automatic document feeder. In this case, it is impossible to appropriately perform control of the automatic document feeder.

A document reading apparatus of Japanese Laid-Open Patent Publication No. 2012-29193 includes a shielding member which moves in conjunction with opening and closing of the automatic document feeder and detects distribution of the light quantity that varies according to a position of the shielding member to thereby detect the opened and closed state of the automatic document feeder, and when the closed state is detected, starts a print preparation action. Accordingly, the document reading apparatus of Japanese Laid-Open Patent Publication No. 2012-29193 does not detect opening and closing of the automatic document feeder after a print job or the like is executed and conveyance of a recording paper is started, and is not able to cope with the automatic document feeder if being opened while the recording paper is conveyed. Moreover, it is impossible to perform processing for cancelling the job or the like at this time.

### SUMMARY OF THE INVENTION

The present invention aims to provide an image processing apparatus which detects an opened state of an automatic document feeder while the automatic document feeder conveys a document, so as to be able to appropriately cope with the automatic document feeder even being in the opened state during execution of a job, and an image forming apparatus including the image processing apparatus.

An object of the present invention is to provide an image processing apparatus including an automatic document feeder for conveying a document to pass through a predetermined image reading position and discharge to a predetermined discharge portion, a main body portion for irradiating the document with light at the image reading position and receiving reflection light of the irradiated light to read an image of the document, and a control portion for controlling processing for conveying the document and reading the image, in which the automatic document feeder is provided so as to be able to be opened and closed with respect to the main body portion, and in a state where the automatic document feeder is closed, the document passing through the image reading position is in close contact with the main body portion, wherein the automatic document feeder has a white plate at a position where light is irradiated from the main body portion in the closed state, and while the automatic document feeder conveys the document, the control portion irradiates the white plate with light in the absence of the document at the image reading position to read an image of the white plate and analyze the read image of the white plate so as to detect opening and closing of the automatic document feeder.

Another object of the present invention is to provide the image processing apparatus, wherein the control portion, when detecting the opening and closing of the automatic document feeder, analyzes density of the read image of the white plate, and if the density is density beyond a predetermined level, detects that the automatic document feeder is in the opened state.

Another object of the present invention is to provide the image processing apparatus, wherein when a job instructing predetermined image processing is executed and the automatic document feeder starts conveyance of the document upon execution of the job, the control portion reads the image of the white plate to detect the opening and closing of the automatic document feeder before the conveyed document passes through the image reading position, and cancels the execution of the job when detecting that the automatic document feeder is in the opened state.

Another object of the present invention is to provide the image processing apparatus, wherein when the job instructing the predetermined image processing is executed, if the automatic document feeder continuously conveys a plurality of documents to be processed, the control portion detects the opening and closing of the automatic document feeder for each of the documents to be conveyed before the documents pass through the image reading position.

Another object of the present invention is to provide an image forming apparatus including the above image processing apparatus, and an image forming portion for performing image formation of the image of the document read by the image processing apparatus on a recording medium.

### BRIEF DESCRIPTION OF THE DRAWINGS

FIG. 1 is a block diagram showing a structure example of an image processing apparatus according to the present invention;

FIG. 2A through FIG. 2C are views explaining an automatic document feeder of the image processing apparatus according to the present invention;

FIG. 3 is a schematic cross-sectional view showing a structure example of an image processing apparatus according to the present invention; and

FIG. 4 is a flowchart showing an example of processing for detecting opening and closing of the automatic document feeder in the image processing apparatus by the present invention.

### PREFERRED EMBODIMENTS OF THE INVENTION

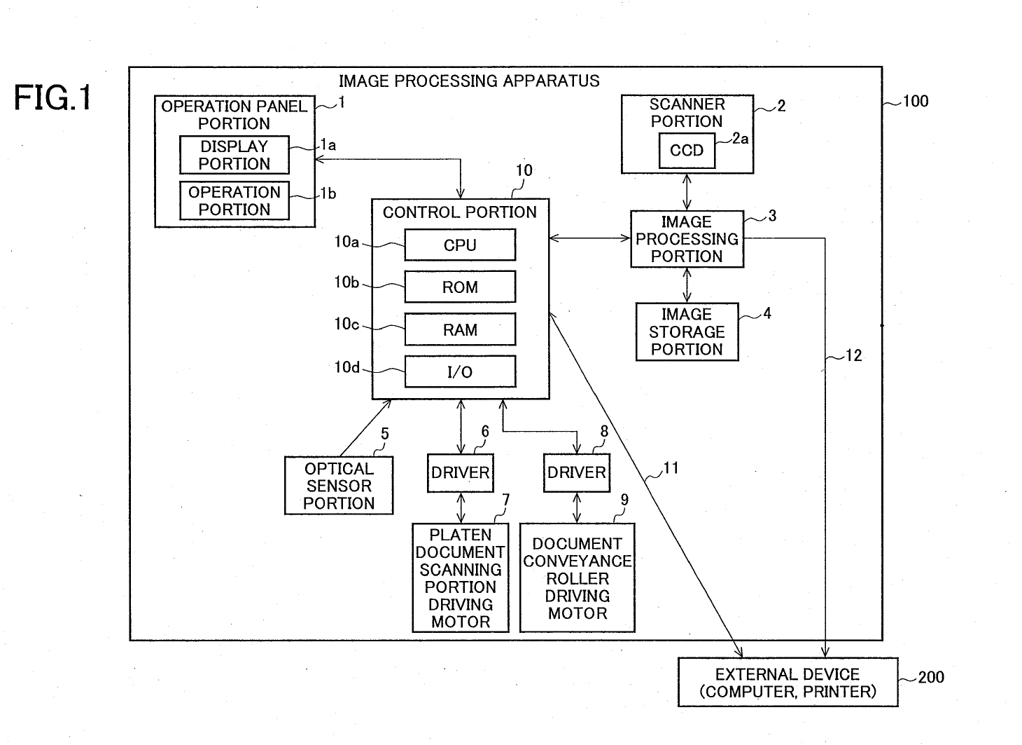

FIG. 1 is a block diagram showing a structure example of an image processing apparatus according to the present invention. An image processing apparatus 100 has an operation panel portion 1 composed of a display portion 1a for displaying a menu, a setting screen and the like, and an operation portion 1b for receiving operation input by a user. The operation panel portion 1 is able to be configured as a touch panel. Moreover, the operation portion 1b is able to include a key operation portion, separately from the touch panel.

The image processing apparatus 100 further includes a scanner portion 2 for reading a document image by a CCD (Charge Coupled Device) 2a, an image processing portion 3 for applying image processing to image data of a document read by the scanner portion 2, a storage portion 4 for storing the image data subjected to the image processing, and an optical sensor portion 5 for judging a size of a document placed on a document loading table of the scanner portion 2 or a document placed on a document loading tray of an automatic document feeder.

Furthermore, the image processing apparatus 100 includes a driving motor 7 for driving a platen document scanning portion which moves in a sub-scanning direction while scanning the document placed on the document loading table with laser and a driver 6 for controlling the driving motor 7, a driving motor 9 for driving a conveyance roller of the automatic document feeder and a driver 8 for controlling the driving motor 9, and a control portion 10 for controlling the whole of the apparatus. The control portion 10 has a CPU 10a, a ROM 10b, a RAM 10c, and an I/O (input/output portion) 10d. Processing for conveying a document and reading a document image is controlled by the control portion 10.

The image processing apparatus 100 is able to be connected to an external device 200 such as a computer or a printer. For example, it is possible that image data of a document read by the scanner portion 2 is transmitted to a printer which is one of the external devices 200 for performing printing or transmitted to a computer for executing image processing or the like. Here, an image data bus 12 connects the image processing portion 3 and the external device 200, and a communication line (communication of control signals and the like) 11 connects the control portion 10 and the external device 200.

An image forming apparatus according to the present invention includes the above-described image processing apparatus, and has a function for performing image formation of image data output from an output portion of the image processing apparatus on a medium such as a recording paper. The image forming apparatus is able to be configured as a multifunction peripheral (MFP) having a plurality of functions of copy, printer, fax and the like. In addition, it is also possible to be configured as a simple digital copier having a copy function or a facsimile apparatus capable of transmitting and receiving facsimile data. As to these image formation functions, a publicly known technology is able to be applied as appropriate.

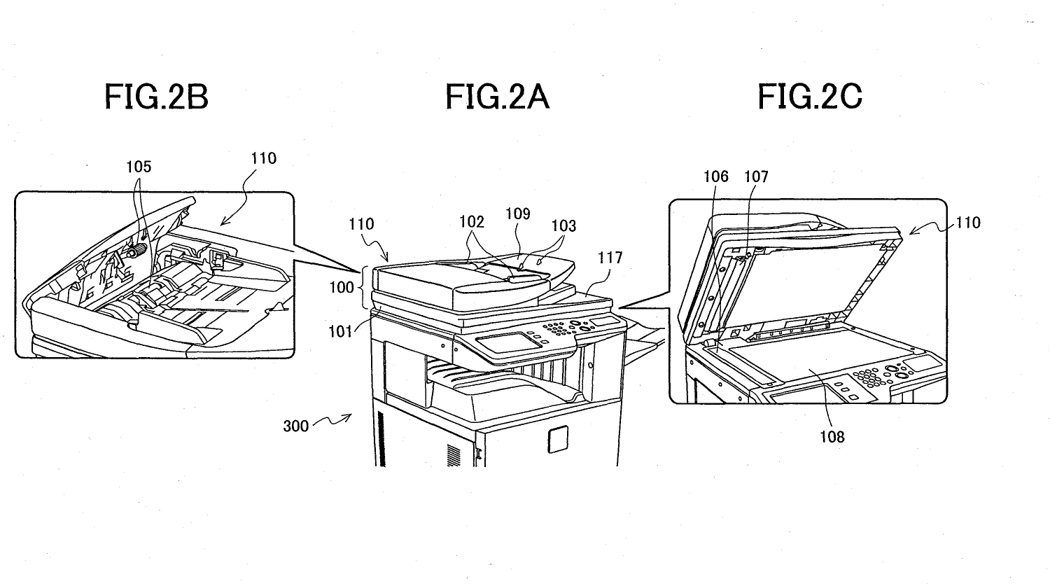

FIG. 2A through FIG. 2C are views explaining the automatic document feeder of the image processing apparatus according to the present invention, and show a structure thereof by taking a multifunction peripheral including the image processing apparatus as an example. FIG. 2A is a top exterior view of the multifunction peripheral including the image processing apparatus, FIG. 2B is a view showing an internal structure of the automatic document feeder, and FIG. 2C is a view showing a state where the automatic document feeder of the image processing apparatus is opened. The multifunction peripheral is an example of the image forming apparatus including the image processing apparatus according to the present invention.

A multifunction peripheral 300 includes the image processing apparatus 100 in an embodiment according to the present invention at the top thereof. As shown in FIG. 2A, the image processing apparatus 100 includes an automatic document feeder (SPF (Single Pass Feeder)) 110 which is attached so as to be opened and closed freely with respect to a main body portion 101. The automatic document feeder 110 automatically conveys a document set on a document loading tray 109 thereof to a document loading table 108 to cause a scanner portion included in the main body portion 101 to read a document image.

The document loading tray 109 includes a document guide 102 for reading a size of a document correctly. When the user sets the document guide 102 according to a size of a document, the image processing apparatus is able to judge the document size in a main-scanning direction (width direction) according to a set position of the document guide 102. Moreover, the document loading tray 109 includes a plurality of sensors 103 for judging a document size in a sub-scanning direction (feed-direction of a document).

The document set on the document loading tray 109 is conveyed in turn by a document feed roller 105 (FIG. 2B) and placed at a predetermined position on the document loading table (platen glass) 108 (FIG. 2C). For the document on the document loading table 108, laser light is directed from a document scanning portion 106 and guided to the CCD, and image data is read. The document whose image data is read is discharged to a document discharge tray 117.

Moreover, when a document for which the automatic document feeder 110 is not able to be used, such as a thick document or a book document in a book shape, is read, the user opens the automatic document feeder 110 and places the document directly on the document loading table 108, without using the automatic document feeder 110.

As shown in FIG. 2C, the automatic document feeder 110 includes a white plate 107 at a position corresponding to the document scanning portion 106. The white plate 107 is provided for correcting sensitivity fluctuations of each pixel at the time of image reading and unevenness in illuminance of document illumination, and this white plate 107 is generally illuminated with the laser light of the scanner portion to be read for performing correction. In the embodiment according to the present invention, using this white plate 107, while a document is conveyed by the automatic document feeder 110, an image of the white plate 107 is read in the absence of the document, and by analyzing the image, opening and closing of the automatic document feeder 110 during execution of a job is detected.

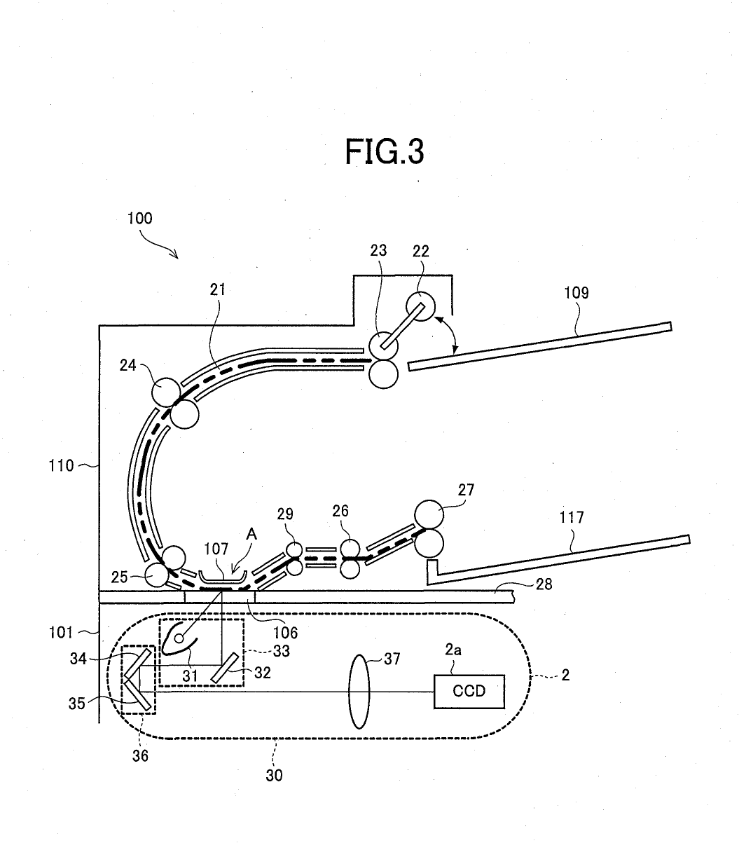

FIG. 3 is a schematic cross-sectional view showing a structure example of an image processing apparatus according to the present invention. The image processing apparatus 100 includes the main body portion 101 and the automatic document feeder 110 provided so as to be opened and closed freely with respect to the main body portion 101. The automatic document feeder 110 rotates with respect to the main body portion 101 by a hinge mechanism so as to be opened and closed with respect to the main body portion 101.

The automatic document feeder 110 includes a document conveyance path 21 in which a document is conveyed from the document loading tray 109 to the document discharge tray 117. The document is conveyed from the document loading ray 109 toward the document discharge tray 117 in the document conveyance path 21.

A pickup roller 22 and a separating roller 23 are arranged at an upstream side end portion of the document conveyance path 21 in the document conveyance direction, and documents loaded on the document loading tray 109 are supplied to the document conveyance path 21 one by one by the pickup roller 22 and the separating roller 23. Moreover, a discharge roller 27 is arranged at a downstream side end portion of the document conveyance path 21 in the document conveyance direction, and the document which is conveyed in the document conveyance path 21 is discharged to the document discharge tray 117 by the discharge roller 27. The document discharge tray 117 corresponds to a discharge portion of the present invention. In addition, the document conveyance path 21 includes a document conveyance sensor which is not shown, to detect a fed document as well as detect a length of the document conveyance direction while the document is conveyed.

An image reading position A by the scanner portion 2 is set at the midway of the document conveyance path 21. In the upstream side of the image reading position A in the document conveyance direction, a conveyance roller 24 and a conveyance roller 25 are arranged along the document conveyance direction. Each of the conveyance rollers 24 and 25 is driven by a document conveyance roller driving motor to convey the document toward the image reading position A.

A driven roller 29 is arranged in the document conveyance path 21 in the downstream side of the image reading position A, and a conveyance roller 26 is arranged in the vicinity of the downstream side. The conveyance roller 26 is driven by the document conveyance roller driving motor to convey the document toward the discharge roller 27.

The main body portion 101 has the scanner portion 2 for reading a document image. The scanner portion 2 includes a first scanning unit 33 provided with an exposure lamp 31 and a first reflection mirror 32, a second scanning unit 36 provided with a second reflection mirror 34 and a third reflection mirror 35, an imaging lens 37, and a CCD 2a.

The image reading position A is a position corresponding to the document scanning portion 106 which scans a document. It is configured such that, when the automatic document feeder 110 is in the closed state, a document which passes through the image reading position A is in close contact with a platen glass 28 of the main body portion 101. On a wall surface facing the platen glass 28 in the document conveyance path 21 at the image reading position A, a white plate (SPF white plate) 107 which is used for shading correction is arranged.

Light irradiated from the exposure lamp 31 penetrates the platen glass 28 of the document scanning portion 106, is irradiated to the document, reflects on a document surface, is reflected by the first reflection mirror 32, the second reflection mirror 34 and the third reflection mirror 35 sequentially, and becomes incident on the imaging lens 37. The imaging lens 37 forms an image from the incident light on the CCD 2a. The CCD 2a receives the light imaged by an imaging lens 37, followed by photoelectric conversion to read as image data.

The scanner portion 2 is configured so as to be displaced freely in the sub-scanning direction along the platen glass 28 on which a document is placed when an image of the document is read by a document fixing system. By displacing the first scanning unit 33 and the second scanning unit 36 in the sub-scanning direction, the scanner portion 2 is able to read an image of the document which is placed and fixed on the platen glass 28 to obtain image data of the image of the document.

Though the scanner portion 2 reads an image of one side of a document, the automatic document feeder 110 is able to include the same structure as that of the scanner portion 2 inside thereof to be configured so as to read an image of the other side of the document.

With the above-described structure, in an embodiment of the image processing apparatus according to the present invention, control is performed such that, upon execution of a job, the automatic document feeder 110 conveys a document, and when an image of the document is read, opening and closing of the automatic document feeder 110 with respect to the main body portion 101 is detected and the execution of the job is stopped according to the detection result.

The detection of opening and closing of the automatic document feeder 110 is executed by the control portion 10 of the image processing apparatus. When a document is conveyed in the document conveyance path 21, the control portion 10 performs control to read an image of the white plate 107 by the scanner portion 2 before the document reaches at the image reading position A. At this time, density of the read image of the white plate 107 is detected to detect opening and closing of the automatic document feeder 110 according to a level of the density.

When the automatic document feeder 110 even slightly rotates with respect to the main body portion 101, it becomes impossible to read the image of the white plate 107 by the scanner portion 2, so that the read image is made blackish. Thereby, the control portion 10 is able to detect opening and closing of the automatic document feeder 110 with respect to the main body portion 101. Here, it is possible to set a predetermined threshold to image density of the read image and judge that the automatic document feeder 110 is in the opened state when the density exceeds the threshold.

The reading of the image of the white plate 107 by the scanner portion 2 is able to be performed, when documents are conveyed in the document conveyance path 21, for each of the documents. Here, when a plurality of documents are set on the document loading tray 109 of the automatic document feeder 110 and operation input for instructing start of a job (for example, pressing of a start key) is performed, the automatic document feeder 110 feeds the documents one by one to the document conveyance path 21 to convey toward the image reading position A. The job is, for example, a job for performing image formation of an image read by the image processing apparatus 100.

At this time, at the image reading position A, when a document is being conveyed in the document conveyance path 21, before the document reaches at the image reading position A, an image of the white plate 107 is read by the scanner portion 2 in the absence of the document at the image reading position A to detect opening and closing of the automatic document feeder 110. As the timing to read the image of the white plate 107, for example, the timing when a leading end of the document which is being conveyed has a few mm to the image reading position A is able to be set.

The control portion 10 then analyzes density of the read image of the white plate 107, and when judging that the automatic document feeder 110 is opened with respect to the main body portion 101, performs control to stop the job promptly. In addition, when the automatic document feeder 110 is not opened, an image of the document is read to execute the job.

After that, when the next document is being conveyed in the document conveyance path 21, reading of the image of the white plate 107 by the scanner portion 2 is performed before the document reaches at the image reading position A. That is, for the second and subsequent documents, it is possible that the image of the white plate 107 is read between documents which are being conveyed and opening and closing of the automatic document feeder 110 is detected.

By performing such an action, even if a document set in the automatic document feeder 110 is started to be conveyed, when the automatic document feeder 110 is opened, it is possible to stop the job promptly. In addition, in the case of an image formation job, it is possible to prevent waste consumption of sheets and toner in the image forming apparatus which performs image formation of image data output from the image processing apparatus. Moreover, since opening and closing of the automatic document feeder 110 is detected by the scanner portion 2 and the white plate 107, it is possible to detect opening and closing of the automatic document feeder without providing a dedicated sensor.

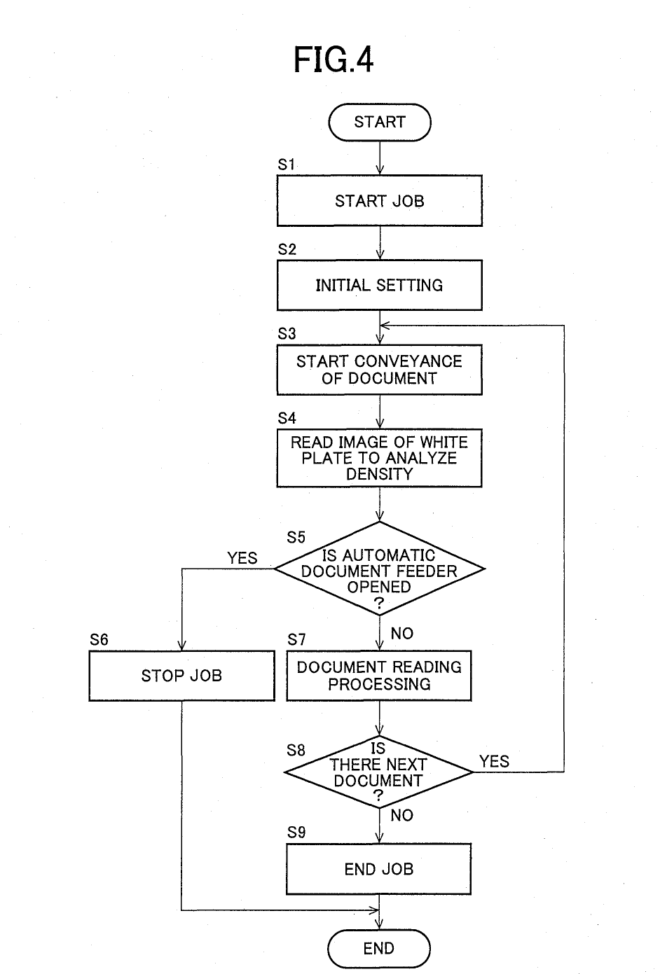

FIG. 4 is a flowchart showing an example of processing for detecting opening and closing of the automatic document feeder in the image processing apparatus by the present invention. First, when a job is started (step Si), the control portion 10 of the image processing apparatus 100 performs initial setting of the image processing apparatus 100 (step S2). This job is a job for reading a document image to output by the image processing apparatus to be subjected to image formation by the image forming apparatus. The initial setting in this case is processing for setting various setting values for activating the image processing apparatus 100 to execute the job.

The control portion 10 then starts conveyance of a document by the automatic document feeder 110 (step S3). Further, before the conveyed document reaches at the image reading position A, the scanner portion 2 reads an image of the white plate 107 and density of the read image is analyzed by the control portion 10 (step S4). In accordance with the density of the read image of the white plate 107, the control portion 10 judges whether or not the automatic document feeder 110 is in the opened state with respect to the main body portion 101 (step S5). When it is judged that the automatic document feeder 110 is opened, the control portion 10 promptly stops the job which has been started (step S6).

On the other hand, when it is judged that the automatic document feeder 110 is closed, the control portion 10 continues the job to cause the scanner portion 2 to execute processing for reading the document (step S7). The control portion 10 then judges whether or not there is a next document to be processed which is set in the automatic document feeder 110 (step S8). Here, when there is not a next document, the job ends (step S9). Alternatively, when there is a next document, the procedure returns to step S3 to start conveyance of the document (step S3).

With this processing, in a case where there are a plurality of documents to be processed, after the job is started, it is possible to detect opening and closing of the automatic document feeder, when each document is conveyed.

With the above-described processing, by detecting the opened state of the automatic document feeder 110 while a document is conveyed by the automatic document feeder 110, by stopping a job, even when the automatic document feeder 110 becomes in the opened state during execution of the job, it is possible to cope with that appropriately. Here, in a case where the job is an image formation job, by stopping the job when the automatic document feeder 110 becomes in the opened state, it is possible to prevent sheets and toner from being wasted. Moreover, since opening and closing of the automatic document feeder 110 is detected each time a document is conveyed, it becomes possible to quickly detect that the automatic document feeder 110 is opened even when a plurality of documents are processed.

As explained above, the image processing apparatus according to the present invention is an image processing apparatus including an automatic document feeder for conveying a document to pass through a predetermined image reading position and discharge to a predetermined discharge portion, a main body portion for irradiating the document with light at the image reading position and receiving reflection light of the irradiated light to read an image of the document, and a control portion for controlling processing for conveying the document and reading the image, in which the automatic document feeder is provided so as to be able to be opened and closed with respect to the main body portion, and in a state where the automatic document feeder is closed, the document passing through the image reading position is in close contact with the main body portion, characterized in that the automatic document feeder has a white plate at a position where light is irradiated from the main body portion in a closed state, and while the automatic document feeder conveys the document, the control portion irradiates the white plate with light in the absence of the document at the image reading position to read an image of the white plate and analyze the read image of the white plate so as to detect opening and closing of the automatic document feeder. Thereby, by detecting the opened state of the automatic document feeder while the document is conveyed by the automatic document feeder, it becomes possible to appropriately cope with the automatic document feeder even being in the opened state during execution of a job.

Further, it is possible in the image processing apparatus of the present invention that the control portion, when detecting opening and closing of the automatic document feeder, analyzes density of the read image of the white plate, and if the density is density beyond a predetermined level, detects that the automatic document feeder is in the opened state. Thereby, by analyzing the density of the white plate, it becomes possible to detect opening and closing of the automatic document feeder appropriately.

Further, it is possible in the image processing apparatus of the present invention that, when a job instructing predetermined image processing is executed and the automatic document feeder starts conveyance of the document upon execution of the job, before the conveyed document passes through the image reading position, the control portion reads the image of the white plate to detect opening and closing of the automatic document feeder, and when detecting that the automatic document feeder is in the opened state, cancels the execution of the job. Thereby, even when the automatic document feeder becomes in the opened state while the job is started and the document is conveyed, it becomes possible to perform control for stopping the job.

Further, it is possible in the image processing apparatus of the present invention that, when the job instructing the predetermined image processing is executed, if the automatic document feeder continuously conveys a plurality of documents to be processed, for each of the documents to be conveyed, before the documents pass through the image reading position, the control portion detects opening and closing of the automatic document feeder. Thereby, even when a plurality of documents are processed, it becomes possible to quickly detect that the automatic document feeder 110 is opened.

Further, an image forming apparatus of the present invention includes the above-described image processing apparatus and an image forming portion for performing image formation of the image of the document read by the image processing apparatus on a recording medium. Thereby, when the automatic document feeder of the image processing apparatus becomes in the opened state after a job is started, by stopping the job, it becomes possible to prevent sheets and toner from being wasted.

As above, according to the present invention, it is possible to provide an image processing apparatus which detects an opened state of the automatic document feeder while the automatic document feeder conveys a document, so as to be able to appropriately cope with the automatic document feeder even being in the opened state during execution of a job, and an image forming apparatus including the image processing apparatus.

1. An image processing apparatus including an automatic document feeder for conveying a document to pass through a predetermined image reading position and discharge to a predetermined discharge portion, a main body portion for irradiating the document with light at the image reading position and receiving reflection light of the irradiated light to read an image of the document, and a control portion for controlling processing for conveying the document and reading the image, in which the automatic document feeder is provided so as to be able to be opened and closed with respect to the main body portion, and in a state where the automatic document feeder is closed, the document passing through the image reading position is in close contact with the main body portion, wherein
the automatic document feeder has a white plate at a position where light is irradiated from the main body portion in the closed state, and
while the automatic document feeder conveys the document, the control portion irradiates the white plate with light in the absence of the document at the image reading position to read an image of the white plate and analyze the read image of the white plate so as to detect opening and closing of the automatic document feeder.

2. The image processing apparatus as defined in claim 1, wherein
the control portion, when detecting the opening and closing of the automatic document feeder, analyzes density of the read image of the white plate, and if the density is density beyond a predetermined level, detects that the automatic document feeder is in the opened state.

3. The image processing apparatus as defined in claim 1, wherein
when a job instructing predetermined image processing is executed and the automatic document feeder starts conveyance of the document upon execution of the job, the control portion reads the image of the white plate to detect the opening and closing of the automatic document feeder before the conveyed document passes through the image reading position, and cancels the execution of the job when detecting that the automatic document feeder is in the opened state.

4. The image processing apparatus as defined in claim 3, wherein when the job instructing the predetermined image processing is executed, if the automatic document feeder continuously conveys a plurality of documents to be processed, the control portion detects the opening and closing of the automatic document feeder for each of the documents to be conveyed before the documents pass through the image reading position.

5. An image forming apparatus including the image processing apparatus as defined in claim 1, and an image forming portion for performing image formation of the image of the document read by the image processing apparatus on a recording medium.
